(19) United States
(12) Patent Application Publication
(10) Pub. No.: US 2026/0128050 A1
(43) Pub. Date: May 7, 2026

(54) COHERENCE CALCULATION FOR STEREO DISCONTINUOUS TRANSMISSION (DTX)

(71) Applicant: Telefonaktiebolaget LM Ericsson (publ), Stockholm (SE)

(72) Inventors: Tomas JANSSON TOFTGÅRD, UPPSALA (SE); Fredrik JANSSON, SUNDBYBERG (SE)

(73) Assignee: Telefonaktiebolaget LM Ericsson (publ), Stockholm (SE)

(21) Appl. No.: 19/118,794

(22) PCT Filed: Sep. 20, 2023
(86) PCT No.: PCT/EP2023/075871

§ 371 Date: Apr. 7, 2025

Related U.S. Application Data
(60) Provisional application No. 63/413,428, filed on Oct. 5, 2022.

(51) Int. Cl. G10L 19/22; G10L 19/012; G10L 19/24

(52) U.S. Cl. CPC G10L 19/22; G10L 19/012; G10L 19/24

(57) ABSTRACT

Enabling generation of comfort noise in an encoder using an estimated coherence parameter in a network using a discontinuous transmission, DTX, includes receiving time domain audio input comprising audio input signals; and processing the input signals on a frame-by-frame basis by: encoding active content of each input signal at a first bit rate until an inactive period is detected in the input signals; switching the encoding from the active encoding to inactive encoding to encode background noise at a second bit rate during the inactive period; estimating coherence parameters during the inactive period based on a low-pass filtering or averaging of cross-spectra including reinitializing a low pass filter state of the cross-spectra based on a coherence parameter from a previous inactive period; encoding the coherence parameters estimated; and initiating transmitting of the encoded active content, background noise, and coherence parameters towards a decoder.

### TECHNICAL FIELD

The present disclosure relates generally to communications, and more particularly to communication methods and related devices and nodes supporting encoding and decoding.

### BACKGROUND

In communications networks, there may be a challenge to obtain good performance and capacity for a given communications protocol, its parameters and the physical environment in which the communications network is deployed.

For example, although the capacity in telecommunication networks is continuously increasing, it is still of interest to limit the required resource usage per user. In mobile telecommunication networks less required resource usage per call means that the mobile telecommunication network can service a larger number of users in parallel. Lowering the resource usage also yields lower power consumption in both devices at the user-side (such as in terminal devices) and devices at the network-side (such as in network nodes). This translates to energy and cost saving for the network operator, while enabling prolonged battery life and increased talk-time to be experienced in the terminal devices.

One mechanism for reducing the required resource usage for speech communication applications in mobile telecommunication networks is to exploit natural pauses in the speech. In more detail, in most conversations only one party is active at a time, and thus the speech pauses in one communication direction will typically occupy more than half of the signal. One way to utilize this property in order to decrease the required resource usage is to employ a Discontinuous Transmission (DTX) system, where the active signal encoding is discontinued during speech pauses.

The encoding process is done on segments of the audio signal(s) referred to as frames where input audio samples during a time interval, typically 10-20 ms, are buffered and used by an encoder to extract the parameters to be transmitted to a decoder.

During speech pauses it is common to transmit so called SID (silence insertion descriptor) frames at a very low bit rate encoding of the background noise to allow for a Comfort Noise Generator (CNG) system at the receiving end to fill the above-mentioned pauses with a background noise having similar characteristics as the original noise. The CNG makes the sound more natural compared to having silence in the speech pauses since the background noise is maintained and not switched on and off together with the speech. Complete silence in the speech pauses is commonly perceived as annoying and often leads to the misconception that the call has been disconnected.

A DTX system might further rely on a Voice Activity Detector (VAD), which indicates to the transmitting device whether to use active signal encoding or low rate background noise encoding. In this respect the transmitting device might be configured to discriminate between other source types by using a (Generic) Sound Activity Detector (GSAD or SAD), which not only discriminates speech from background noise but also might be configured to detect music or other signal types, which are deemed relevant. A block diagram of a DTX system 100 is illustrated in FIG. 1.

In FIG. 1, input audio is received by the VAD 102, the speech/audio coder 104, and the CNG coder 106. The VAD 102 indicates whether to transmit the “high” bitrate from speech/audio coder 104 or transmit the “low” bitrate from CNG coder 106.

Communication services may be further enhanced by supporting stereo or multichannel audio transmission. In these cases, the DTX/CNG system might also consider the spatial characteristics of the signal in order to provide a pleasant-sounding comfort noise.

A common mechanism to generate comfort noise is to transmit information about the energy and spectral shape of the background noise in the speech pauses. This can be done using significantly lower number of bits than the regular coding of speech segments. Normally this information is sent less frequent than in the active segments as illustrated in FIG. 2 where the active segments are illustrated as active encoding and the information about the energy and spectral shape of the background noise in the speech pauses are illustrated as CN encoding.

A common feature in DTX systems is to add a so called “hangover period” to the VAD decision as illustrated in FIG. 3. During this period active encoding will still be used even though the VAD decision is that there should not be active encoding. This is to avoid short segments of CNG in the middle of longer active segments, e.g., in breathing pauses in a speech utterance. Parameters used for CNG generation can be estimated during this period.

At the receiving side, the comfort noise is generated by creating a pseudo random signal and then shaping the spectrum of the signal with a filter based on information received from the transmitting device. The signal generation and spectral shaping can be performed in the time or the frequency domain.

For stereo operation, additional parameters are transmitted to the receiving side. In a typical stereo signal, the channel pair shows a high degree of similarity, or correlation. State-of-the-art stereo coding schemes exploit this correlation by employing parametric coding, where a single channel is encoded with high quality and complemented with a parametric description that enables reconstruction of the full stereo image. The process of reducing the channel pair into a single channel is often called a down-mix and the resulting channel the down-mix or mixdown channel. The down-mix procedure typically tries to maintain the energy by aligning inter-channel time differences (ITD) and inter-channel phase differences (IPD) before mixing the channels. To maintain the energy balance of the input signal, the inter-channel level difference (ILD) is also measured. The ITD, IPD and ILD are then encoded and may be used in a reversed up-mix procedure when reconstructing the stereo channel pair at a decoder. FIG. 4 and FIG. 5 show block diagrams of a parametric stereo encoder 400 and decoder 500.

In FIG. 4, time domain stereo input is received by the stereo processing and mixdown module 402. The stereo processing and mixdown module 402 processes the time domain stereo input signals and produces a mono mixdown signal and stereo parameters. The mono mixdown signal is received by the mono speech/audio encoder 404, which processes the mono mixdown signal and produces an encoded mono signal. The encoded mono signal and stereo parameters are transmitted towards a decoder such as the parametric stereo decoder 500.

In FIG. 5, the encoded mono signal is received by the mono speech/audio decoder 502 which decodes the encoded mono signal and produces a mono mixdown signal. The mono mixdown signal and stereo parameters are received by the stereo processing and upmix decoder 504, which processes the mono mixdown signal and stereo parameters and produces time domain stereo output. The time domain stereo output can be stored or sent to an audio player for playback.

In addition to ITD, IPD and ILD, the coherence between the left and right channel can be calculated at the encoder and transmitted to the receiving side. The coherence basically describes how correlated the left and right signal are at different frequencies.

For DTX operation and CNG, a parametric representation of the spatial characteristics (stereo image in case of stereo audio) is particularly relevant as it is a compact representation. The same or similar parameters as is used for a parametric stereo encoding mode for active frames may be transmitted in Silent Insertion Descriptor (SID) frames for comfort noise generation at the decoder. Larger quantization errors may however be allowed for SID frames without significant perceptual degradation, which means even fewer bits can be used to represent the spatial characteristics for CNG than for active encoding frames.

If coherence parameters are used to represent properties of the spatial audio for CNG, the coherence can be reconstructed at the decoder and a comfort noise signal with similar properties as the original sound can be created. For further details see U.S. Patent Application Publication No. 20170047072. Note that typically additional parameters (e.g., ILD, IPD, ITD parameters) are needed to capture/represent all of the perceptually most relevant spatial characteristics and would be transmitted together with the coherence in the SID frames.

A solution for efficient representation of the coherence is described in PCT publication WO2019193173 where the coherence is calculated with a high frequency resolution in the transmitter and then divided into a small number of frequency bands and the coherence within each band is weighted together into one value per band. The vector containing the coherence per band is then encoded and transmitted to the decoder.

The stereo coder receives a channel pair [l(m, n) r(m, n)] as input, where l(m, n) and r (m, n) denote the input signals for the left and right channel respectively for sample index n of frame m. The audio is processed in frames of length N samples at a sampling frequency Fₛ, where the length of the frame may include an overlap (look-ahead and memory of past samples). Typically, 20 ms of new audio samples are buffered and included in the frame being encoded.

The coding parameters like the ITD are estimated at the encoding side on a per frame basis and are transmitted to the decoder. It is also common to not transmit a parameter if there is no clear gain in the encoding process with using the parameter. In the ITD case, this will be when the left and right signals are more or less uncorrelated.

The input signal is transformed to frequency domain by means of a e.g., a DFT (discrete Fourier transform) or any other suitable filter-bank or transform such as QMF, Hybrid QMF (quadrature mirror filter) or MDCT (modified discrete cosine transform). In case DFT or MDCT is used, the input signal is typically windowed before the transform. The choice of window depends on various parameters, such as time and frequency resolution characteristics, algorithmic delay (overlap length), reconstruction properties, etc. In the case of a DFT, the spectra of the left and the right audio channel can be obtained as:

$$[ {l}_{win} ( m , n ) {r}_{win} ( m , n ) ] = [ l ( m , n ) wi n ( n ) r ( m , n ) wi n ( n ) ] , n = 0 , 1 , 2 , … , N - 1$$

$$[ SPD\_L ( m , k ) SPD\_R ( m , k ) ] = [ D F T ( {l}_{win} ( m , n ) ) DF T ( {r}_{win} ( m , n ) ) ] , \{ \begin{matrix}n = 0 , 1 , 2 , … , N - 1 \\ k = 0 , 1 , 2 , … , N - 1 \\ m = 0 , 1 , 2 , …\end{matrix}$$

where win (n) is the chosen window function.

A general definition of the channel coherence C_{gen}(f) for frequency f is

$${C}_{g e n} ( f ) = \frac{\vert {S}_{x y} ( f ) {\vert}^{2}}{{S}_{x} ( f ) {S}_{y} ( f )}$$

where Sₓ(f) and S_{y}(f) represent the frequency spectra of the two channels x and y and S_{xy}(f) is the cross-spectrum. Operating in the DFT domain, the coherence can be estimated based on the cross and power spectra according to

$$C ( k , m ) = \frac{{\vert Xspe c ( k , m ) \vert}^{2}}{\vert SPD\_L ( m , k ) {\vert}^{2} \vert SPD\_R ( m , k ) {\vert}^{2}}$$

$$Xspec ( k , m ) = SPD\_L ( m , k ) * SPD\_R ( m , k )$$

$$where * denotes the complex conjugate$$

This however relies on good estimates of the cross and power spectra, which e.g., may be obtained using the well-known Welch's method. Another method to stabilize the coherence estimate is to low-pass filter the short-time spectra Xspec(k, m), SPD_L(m, k) and SPD_R(m, k) with a first order low pass filter before being used in the coherence calculation as being shown in the equations below.

$$X s p e {c}_{smooth} [ k , m ] = ( 1 - α ) \cdot Xspe {c}_{smooth} [ k , m - 1 ] + α \cdot Xspec ( k , m )$$

$${SPD\_L}_{smooth} [ k , m ] = ( 1 - α ) \cdot {SPD\_L}_{smooth} [ k , m - 1 ] + α \cdot SPD\_L ( m , k )$$

$${SPD\_R}_{smooth} [ k , m ] = ( 1 - α ) \cdot {SPD\_R}_{smooth} [ k , m - 1 ] + α \cdot SPD\_R ( m , k )$$

Then the coherence may be obtained as:

$$C ( k , m ) = \frac{\vert Xspe {c}_{smooth} [ k , m ] {\vert}^{2}}{\vert {SPD\_L}_{smooth} [ k , m ] {\vert}^{2} \vert {SPD\_R}_{smooth} [ k , m ] {\vert}^{2}}$$

A rather small value of a is required to get a good and stable coherence estimate. FIG. 7 shows two examples where fixed filter coefficients of (a) α=0.8 and

$$( b ) α = \frac{1}{32} = 0.03$$

has been applied for estimating the coherence of two signals having a fixed coherence 0.2 over all frequencies. It can be seen that in the initial frame, where the cross and power spectra smoothing filters just contain information from the current frame, the coherence will be 1 for all frequencies in both cases. However, for later frames there is a significant difference. While the coherence estimate is gradually approaching the true coherence values for (b), there is a significant amount of noise in the estimate for (a). In FIG. 8, averaging over frequency we can see that the coherence estimate for (b) is indeed approaching the true coherence (0.2 in this case) while for (a) there is a clear bias in the coherence estimate.

In a DTX solution where the coherence is only used in the generation of the comfort noise, the update of the low pass filters may be skipped during speech segments, i.e., when the VAD indicates speech or active content. The reason is that otherwise the speech signal will be present in the low pass filter state for some time after the speech has stopped and a new comfort noise segment has started, which will cause a bias in the coherence estimate for the background signals.

To reduce the number of bits to encode the coherence values, the spectrum is divided into N_{band} number of bands as shown in FIG. 6 and in the equation below.

$${C}_{b a n d} ( b , m ) = \frac{{\sum }_{k = bandlimit ( b )}^{bandlimit ( b + 1 ) - 1} C ( k , m )}{bandlimits ( b + 1 ) - bandlimits ( b )} b = 0 , 1 , … , {N}_{b a n d} - 1$$

where bandlimits(b) is a vector containing the limits between the frequency bands.

The width of these bands aims to mimic the frequency resolution of the human auditory perception, with narrow bands for the low frequencies and increasing bandwidth for higher frequencies.

Instead of using the average of the coherence within one band a weighted mean can used for each band where the DFT energy spectrum |LR(m, k)|² for the mono signal being a downmix of the input signals, e.g., lr(m, n)=l(m, n)+r(m, n), is used as the weighting function. Details can be found in PCT publication WO2019193156. With the weighting function, the equation can be written as

$${C}_{b a n d} ( b , m ) = \frac{{\sum }_{k = bandlimit ( b )}^{bandlimit ( b + 1 ) - 1} C ( k , m ) \cdot {\vert LR ( m , k ) \vert}^{2}}{{\sum }_{k = bandlimit ( b )}^{bandlimit ( b + 1 ) - 1} {\vert LR ( m , k ) \vert}^{2}} b = 0 , 1 , … , {N}_{b a n d} - 1$$

### SUMMARY

There currently exist certain challenge(s). If the smoothed left and right power spectra and the cross spectrum used in the coherence calculation contain parts in time where a speech signal is present they may not reflect the characteristics of the background noise and lead to an incorrect generation of comfort noise. One reason for this may be that the last frame before a speech segment contains the onset of the speech segment. The energy of this part may be too low and/or other features of the audio signal may not be enough to trigger the VAD to detect speech but it may still have a negative influence on the background noise coherence estimation.

One solution to this problem is to store the left and right spectra and the cross spectrum for the previous frame and remove it from the low pass filter states if the next frame is a speech frame. However, with a high resolution DFT, this may mean that several kilowords of memory have to be spent on storing the previous value.

Certain aspects of the disclosure and their embodiments may provide solutions to these or other challenges and improve the coherence estimation in the speech pauses by minimizing the influence of the speech parts. The various embodiments described herein determine coherence for a small number of frequency bands and use the coherence in creating a filter state for the low pass filters that reflects the previous background noise.

According to some embodiments, a method in an encoder to enable generation of comfort noise using an estimated coherence parameter in a network using a discontinuous transmission, DTX, includes receiving a time domain audio input comprising audio input signals. The method includes processing the audio input signals on a frame-by-frame basis by: encoding active content of each audio input signal at a first bit rate until an inactive period is detected in the audio input signals; switching the encoding from the active encoding content to inactive encoding to encode background noise at a second bit rate during the inactive period; estimating coherence parameters during the inactive period based on a low-pass filtering of cross-spectra or averaging of the cross-spectra, wherein estimating the coherence parameters comprises reinitializing a low pass filter state of the cross-spectra based on a coherence parameter from a previous inactive period; encoding the coherence parameters estimated; and initiating transmitting of the active content encoded, the background noise encoded, and the coherence parameters encoded towards a decoder.

Analogous encoders, computer programs, and computer program products are also provided.

Certain embodiments may provide one or more of the following technical advantage(s). The various embodiments make the comfort noise sound more natural and avoid annoying effects of a sudden change in the spatial characteristics during CNG after changing from active coding. In particular one avoids that the DTX starts with a segment of comfort noise colored by the active content and then, after some time, suddenly changes to a comfort noise more closely resembling the original input noise. The various embodiments can estimate the coherence and minimize the influence of the speech parts in the estimate.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of a DTX system;

FIG. 2 is a flow diagram illustrating CNG parameter encoding and transmission;

FIG. 3 is a flow diagram illustrating a VAD (or DTX) hangover period;

FIG. 4 is a block diagram of a parametric stereo encoder;

FIG. 5 is a block diagram of a parametric stereo decoder according to some embodiments;

FIG. 6 is an illustration of a coherence band partitioning according to some embodiments;

FIG. 7 is an illustration of a coherence estimate of stereo signals according to some embodiments;

FIG. 8 is a graph illustrating an average over frequency of coherence estimates for stereo signals with fixed filter coefficients;

FIG. 9 is a graph illustrating estimating coherence according to the various embodiments compared to resetting of cross and power spectra;

FIG. 10 is a flow diagram illustrating filter state initialization according to some embodiments;

FIG. 11 is a flow diagram illustrating coherence memory shifting according to some embodiments;

FIG. 12 is a block diagram illustrating an operating environment of the parametric stereo encoder and the parametric stereo decoder according to some embodiments;

FIG. 13 is a block diagram of an encoder in accordance with some embodiments;

FIG. 14 is a block diagram of a decoder in accordance with some embodiments;

FIG. 15 is a block diagram of a host in accordance with some embodiments;

FIG. 16 is a block diagram of a virtualization environment in accordance with some embodiments; and

FIGS. 17-24 are flow charts illustrating operations of an encoder according to some embodiments.

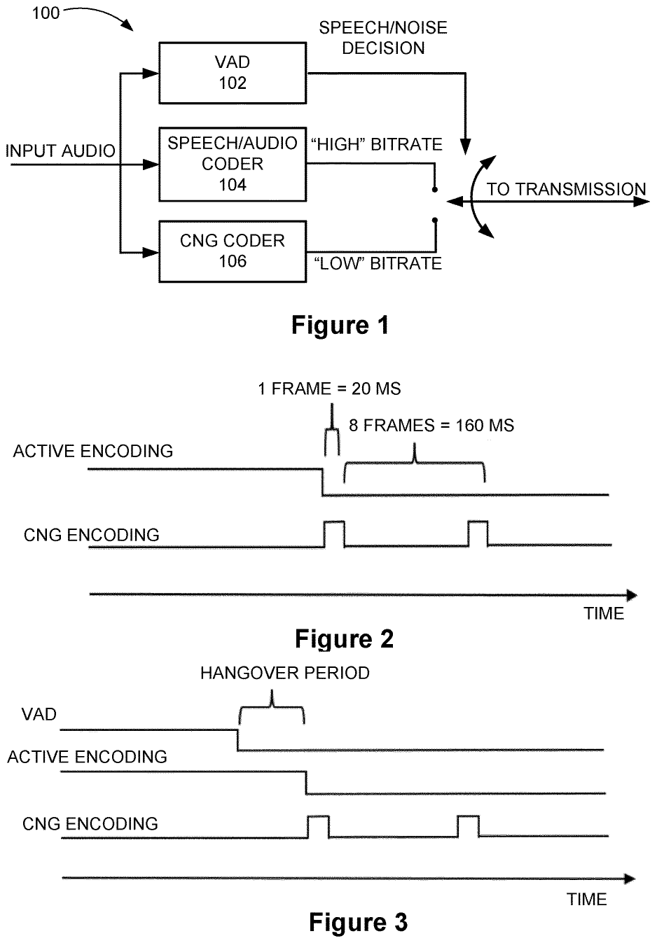

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, avoiding the annoying effects of a sudden change in the spatial characteristics during CNG after changing from active coding will make the comfort noise sound more natural.

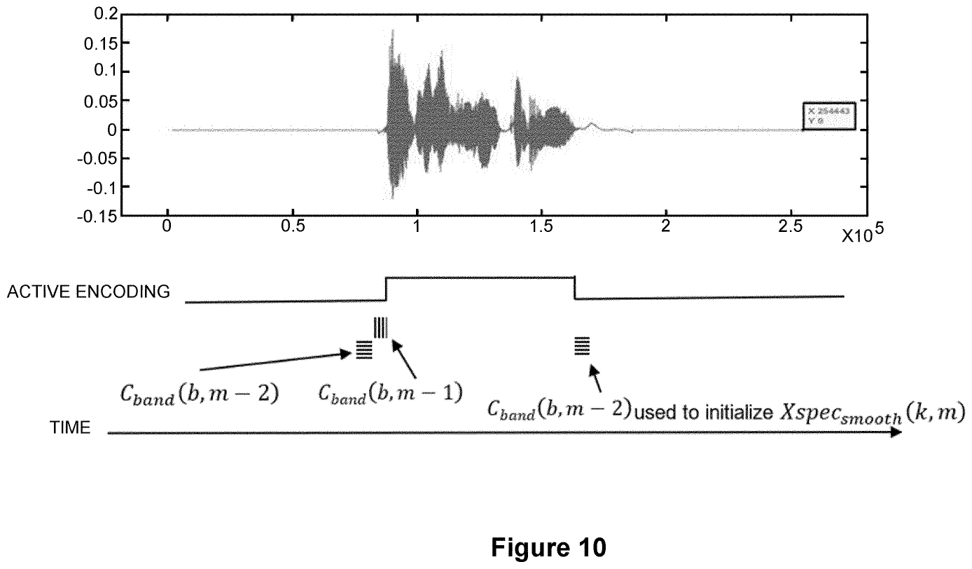

The various embodiments calculate a set of coherence values for each frame where the VAD or SAD signals non-speech. These coherence values are stored for at least two frames back in time. FIG. 10 illustrates two frames back in time. In some embodiments, more coherence values can be used. In the description that follows, the last two frames will be used to describe these embodiments.

When a new inactive segment is started the low pass filter state of the cross spectra Xspec(k, m) is initialized to

$$X s p e {c}_{smooth} [ k , m ] = \sqrt{{C}_{b a n d} ( b , m - 2 ) \cdot \vert {SPD\_L}_{smooth} [ k , m ] {\vert}^{2} \cdot \vert {SPD\_R}_{smooth} [ k , m ] {\vert}^{2} \cdot rand ( k ) ,}$$

$$\begin{matrix}∀ k ∈ {k}_{b} & b = 0 , 1 , … , {N}_{b a n d} - 1\end{matrix}$$

rand(k) is a complex number with an absolute value=1 and a random phase where k_{b} is the set of frequency coefficients for band b.

Note that the smoothed left and right spectra SPD_Lₛₘₒₒₜₕ and SPD_Rₛₘₒₒₜₕ is used as is:

$${SPD\_L}_{smooth} [ k , m ] = ( 1 - α ) \cdot {SPD\_L}_{smooth} [ k , m - 1 ] + α \cdot SPD\_L ( m , k )$$

$${SPD\_R}_{smooth} [ k , m ] = ( 1 - α ) \cdot {SPD\_R}_{smooth} [ k , m - 1 ] + α \cdot SPD\_R ( m , k )$$

where α is a smoothing coefficient.

This initialization will make the coherence calculation give the result of C_{band}(b, m−2). This in itself is not the important thing, C_{band}(b, m−2) can be used directly for the first frame in an inactive segment instead of recalculating the coherence using the updated Xspecₛₘₒₒₜₕ filter state. The important thing is that the Xspecₛₘₒₒₜₕ filter state starts from a point that gives the same coherence as in the end of the previous inactive segment.

Note that in other embodiments, other frames near the end of the last inactive period may be used. For example, C_{band}(b, m−3) could be used that would most likely give very little difference in performance and the memory use will increase only by a small amount.

In some scenarios, Xspecₛₘₒₒₜₕ has been set to zero in the beginning of the VAD hangover period and then updated during the hangover period and the first inactive frame. In this case, Xspecₛₘₒₒₜₕ will not have been updated sufficiently number of times to give a reliable coherence estimate but using the phase information from Xspecₛₘₒₒₜₕ when calculating the initialization values have shown to give an improvement over using random numbers. This is done by scaling Xspecₛₘₒₒₜₕ[k, m] with its absolute value to give a complex number with absolute value 1 but with the phase of Xspecₛₘₒₒₜₕ[k, m].

$$Xspe {c}_{smooth} [ k , m ] = \sqrt{{C}_{b a n d} ( b , m - 2 ) \cdot \vert {SPD\_L}_{smooth} [ k , m ] {\vert}^{2} \cdot \vert {SPD\_R}_{smooth} [ k , m ] {\vert}^{2}} \frac{Xspe {c}_{smooth} [ k , m ]}{\vert Xspe {c}_{smooth} [ k , m ] \vert}$$

$$∀ k ∈ {k}_{b} \qquad b = 0 , 1 , … , {N}_{b a n d} - 1$$

where k_{b} is the set of frequency coefficients for band b.

For clarity, a first Xspecₛₘₒₒₜₕ[k, m] is calculated using Xspec [k, m]=(1−α)·Xspecₛₘₒₒₜₕ[k, m−1]+α·Xspec(k, m) and the phase of the calculated result is kept by normalizing the calculated result

$$\frac{Xspe {c}_{s m o o t h} [ k , m ]}{\vert Xspe {c}_{s m o o t h} [ k , m ] \vert}$$

and further scaling it by \sqrt{C_{band}(b, m−2)·|SPD_Lₛₘₒₒₜₕ[k, m]|²·|SPD_Rₛₘₒₒₜₕ[k, m]|²}.

A special case that needs to be handled is if an inactive segment is only one frame long. Then C_{band}(b, m−2) would be used to initialize the Xspecₛₘₒₒₜₕ[k, m] filter state as described above. At this point in time C_{band}(b, m−1) will be taken from the last frame of the previous inactive segment, i.e., a frame that could contain part of the speech onset. In normal operation C_{band}(b, m−2) would be updated to C_{band}(b, m−1) but in this case this would lead to that C_{band}(b, m−2) could contain an onset frame which is what one wants to avoid. The solution to this is to not update C_{band}(b, m−2) in the first frame of an inactive segment but first in the second frame of an inactive segment.

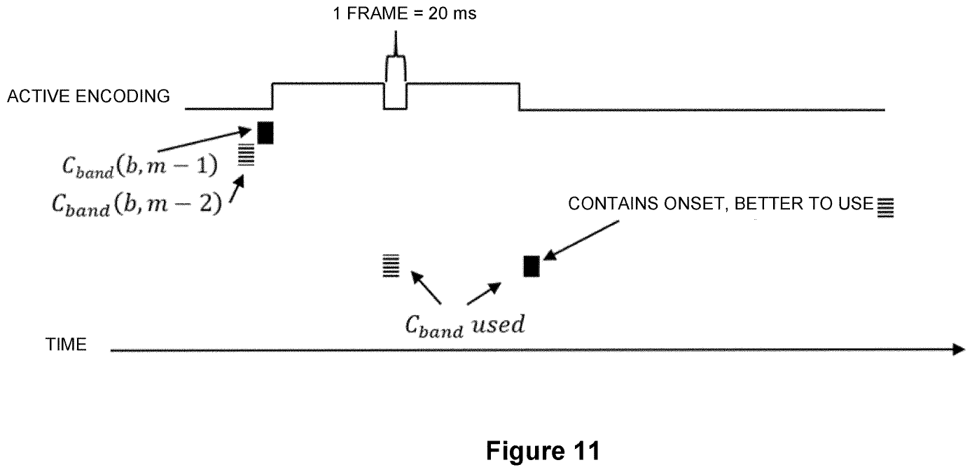

This issue is illustrated in FIG. 11 where the dashed frame is used in the one frame long inactive segment and the solid frame containing an onset would be used in the next inactive segment. If C_{band}(b, m−2) is not updated in the first frame of an inactive segment the dashed frame would be used instead.

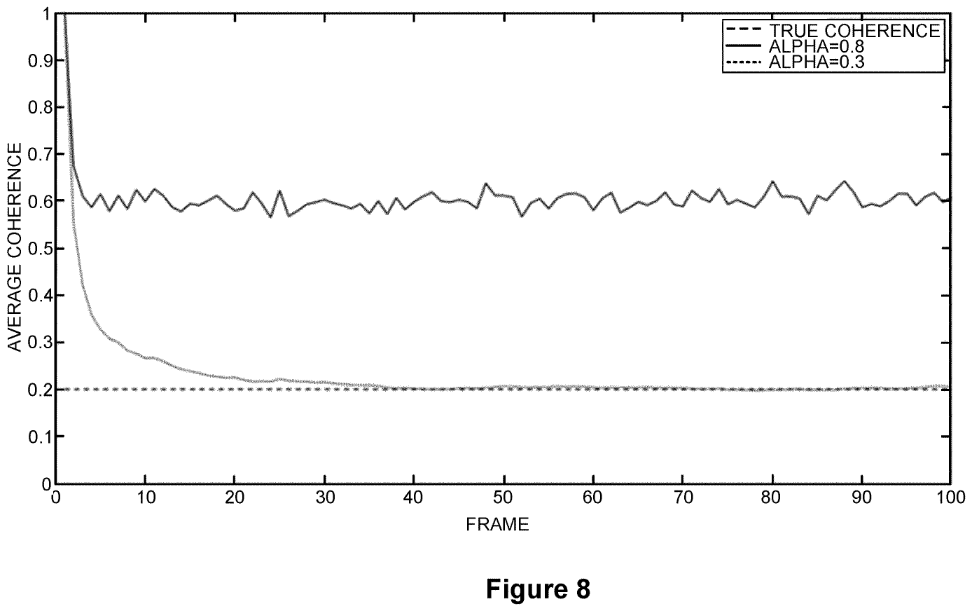

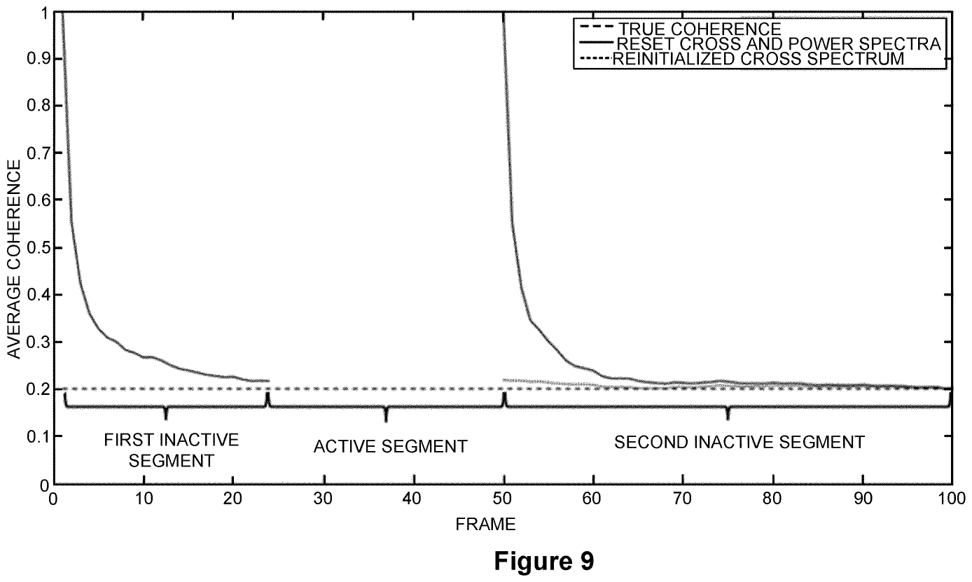

FIG. 9 illustrates the advantage of the disclosed method in estimating coherence for segments of inactive encoding being transmitted in SID frames to be used for CNG at the receiving side. Just like FIG. 8, an average over frequencies is plotted. The true coherence of the signals is fixed 0.2 over all frequencies. It can be seen that the proposed method maintains a good coherence estimate while resetting the cross and power spectra restarts the estimation process. Restarting the estimation process means there will be inaccurate coherence estimates in the beginning of the second inactive segment.

One reason for resetting the cross spectrum during active segments can be for improved ITD estimation for an inactive segment which would otherwise rely on cross spectrum data heavily influenced by the ITD of the active speech segments. It can also be advantageous to increase the filter coefficient α in the hangover period and as can be seen from Error! Reference source not found., having a large filter coefficient will result in unstable coherence estimates. However, with the proposed method of reinitialized cross-spectrum, a stable and reliable coherence estimate, as well as an accurate ITD estimate can be obtained while minimizing the memory footprint. The same memory can be used to store a cross spectrum filter state, which may be reset and more quickly updated during hangover periods to subsequently be copied over to another cross spectrum filter state and used for ITD estimation during segments of inactive encoding (CNG), as well as used to store a cross spectrum estimate to be used for estimating the coherence in the segments of inactive coding. Consequently, two filter state vectors may be used for cross spectrum estimates instead of three, which for a high resolution DFT can imply significant amount of memory, especially for application in codecs targeting mobile devices or any other devices with limited memory capacity.

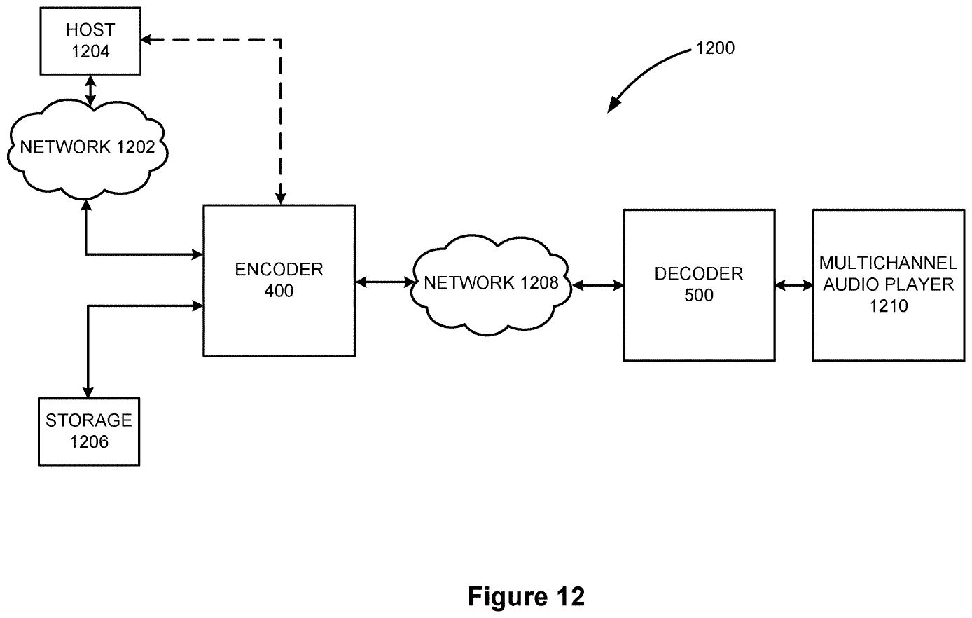

Prior to describing operations from the perspective of the encoder 400, FIG. 12 is a block diagram of an example of an operating environment 1200 where the encoder 400 and decoder 500 may be implemented. In FIG. 12, the encoder 400 receives data, such as an audio file, to be encoded from an entity through network 1202, such as a host 1204, and/or from storage 1206. In some embodiments, the host 1204 may communicate directly to the encoder 400. The 1204 host may be comprised in various combinations of hardware and/or software, including a UE, a mobile phone, a terminal, a standalone server, a blade server, a cloud-implemented server, a distributed server, a virtual machine, container, or processing resources in a server farm and the like. The encoder 400 encodes the audio file as described herein and either stores the encoded audio file in storage 1206 and/or transmits the encoded audio file to decoder 500 via network 1208. The decoder 500 decodes the audio file and transmits the decoded audio file to an audio player for playback such as multichannel audio player 1210. The decoder 500 may be in a UE, a mobile phone, a terminal, and the like. The multichannel audio player 1210 may be comprised in a user equipment, a terminal, a mobile phone, and the like.

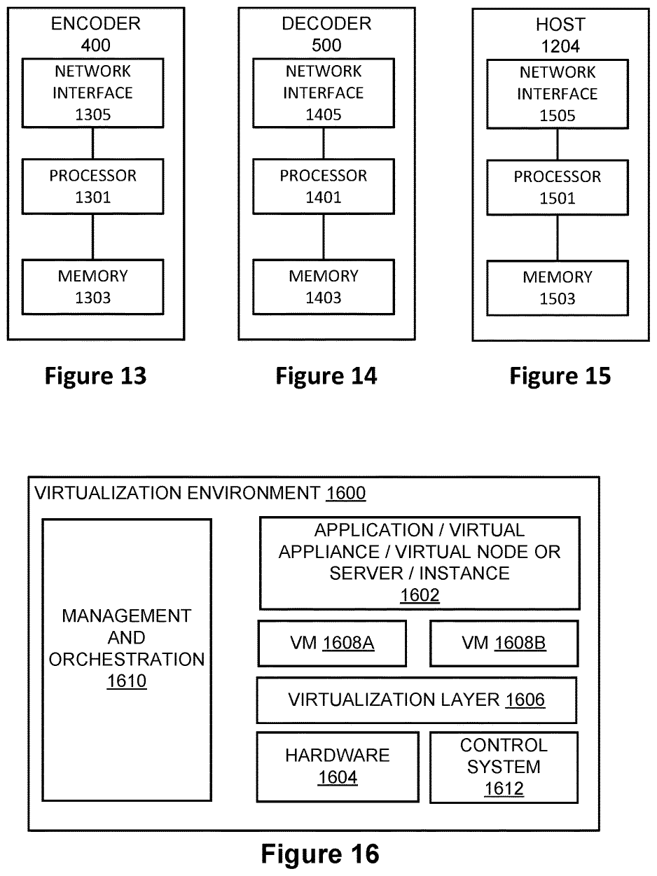

FIG. 13 is a block diagram illustrating elements of the encoder 400 configured to encode audio frames according to the various embodiments herein. As shown, encoder 400 may include a network interface circuitry 1305 (also referred to as a network interface) configured to provide communications with other devices/entities/functions/etc. The encoder 400 may also include processing circuitry 1301 (also referred to as a processor and processor circuitry) coupled to the network interface circuitry 1305, and a memory circuitry 1303 (also referred to as memory) coupled to the processing circuit. The memory circuitry 1303 may include computer readable program code that when executed by the processing circuitry 1301 causes the processing circuit to perform operations according to embodiments disclosed herein.

According to other embodiments, processing circuitry 1301 may be defined to include memory so that a separate memory circuit is not required. As discussed herein, operations of the encoder 400 may be performed by processing circuitry 1301 and/or network interface 1305. For example, processing circuitry 1301 may control network interface 1405 to transmit communications to decoder 500 and/or to receive communications through network interface 1305 from one or more other network nodes/entities/servers such as other encoder nodes, depository servers, etc. Moreover, modules may be stored in memory 1303, and these modules may provide instructions so that when instructions of a module are executed by processing circuitry 1301, processing circuitry 1301 performs respective operations.

FIG. 14 is a block diagram illustrating elements of decoder 500 configured to decode audio frames according to some embodiments of inventive concepts. As shown, decoder 120 may include a network interface circuitry 1405 (also referred to as a network interface) configured to provide communications with other devices/entities/functions/etc. The decoder 500 may also include a processing circuitry 1401 (also referred to as a processor or processor circuitry) coupled to the network interface circuit 1405, and a memory circuitry 1403 (also referred to as memory) coupled to the processing circuit. The memory circuitry 1403 may include computer readable program code that when executed by the processing circuitry 1401 causes the processing circuit to perform operations according to embodiments disclosed herein.

According to other embodiments, processing circuitry 1401 may be defined to include memory so that a separate memory circuit is not required. As discussed herein, operations of the decoder 500 may be performed by processor 1401 and/or network interface 1405. For example, processing circuitry 1401 may control network interface circuitry 1405 to receive communications from encoder 400. Moreover, modules may be stored in memory 1403, and these modules may provide instructions so that when instructions of a module are executed by processing circuitry 1401, processing circuitry 1401 performs respective operations.

FIG. 15 is a block diagram illustrating elements of host 1204 configured to provide audio files to the encoder for encoding the audio files and sending the encoded audio file to the decoder 500 according to some embodiments. As shown, the host 1204 may include a network interface circuitry 1505 (also referred to as a network interface) configured to provide communications with other devices/entities/functions/etc. The host 1204 may also include a processing circuitry 1501 (also referred to as a processor or processor circuitry) coupled to the network interface circuit 1505, and a memory circuitry 1503 (also referred to as memory) coupled to the processing circuit. The memory circuitry 1503 may include computer readable program code that when executed by the processing circuitry 1501 causes the processing circuit to perform operations according to embodiments disclosed herein.

According to other embodiments, processing circuitry 1501 may be defined to include memory so that a separate memory circuit is not required. As discussed herein, operations of the host 1204 may be performed by processor 1501 and/or network interface 1505. For example, processing circuitry 1501 may control network interface circuitry 1505 to transmit communications to the encoder 400. Moreover, modules may be stored in memory 1503, and these modules may provide instructions so that when instructions of a module are executed by processing circuitry 1501, processing circuitry 1501 performs respective operations.

The encoder 400 and decoder 500 may be virtualized in some embodiments by distributing the encoder 400 and/or decoder 500 across various components. FIG. 16 is a block diagram illustrating an example of a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608A and 1608B (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g., such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

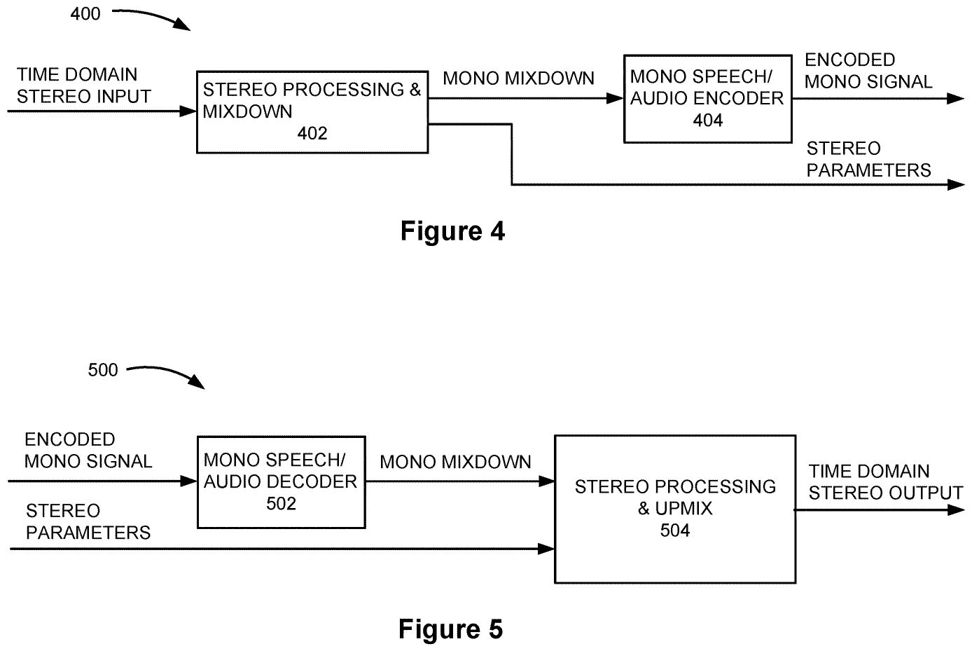

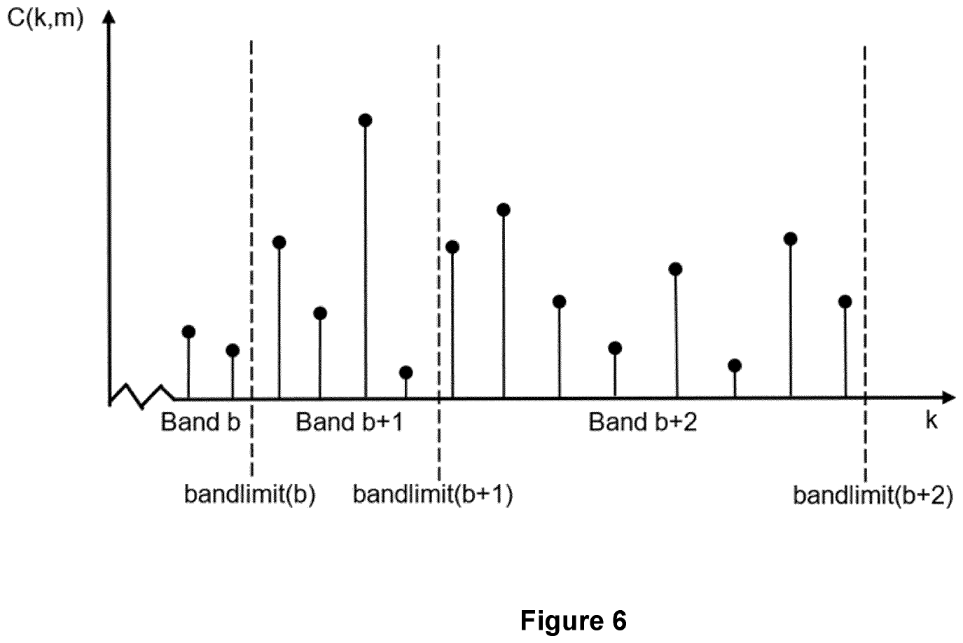

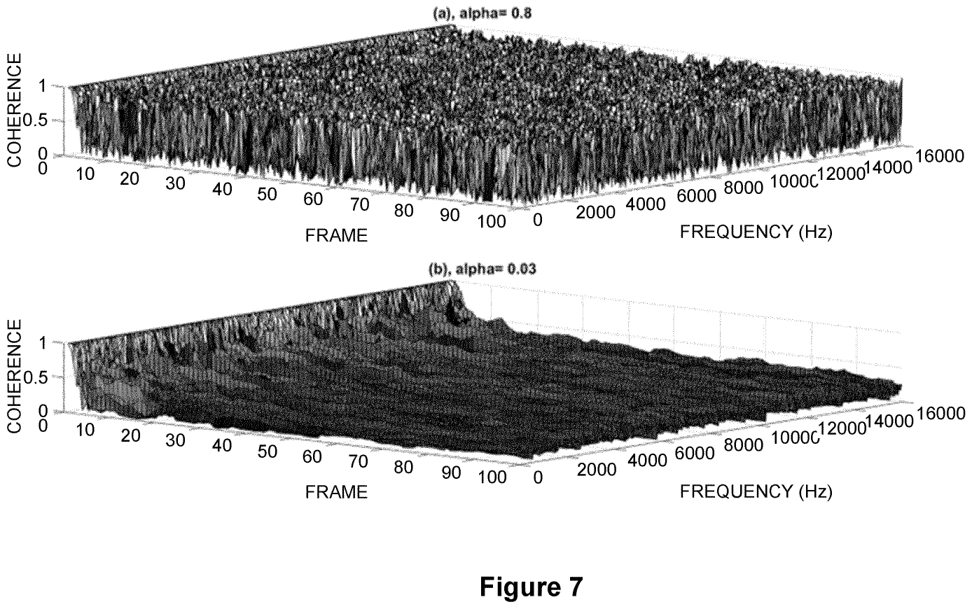

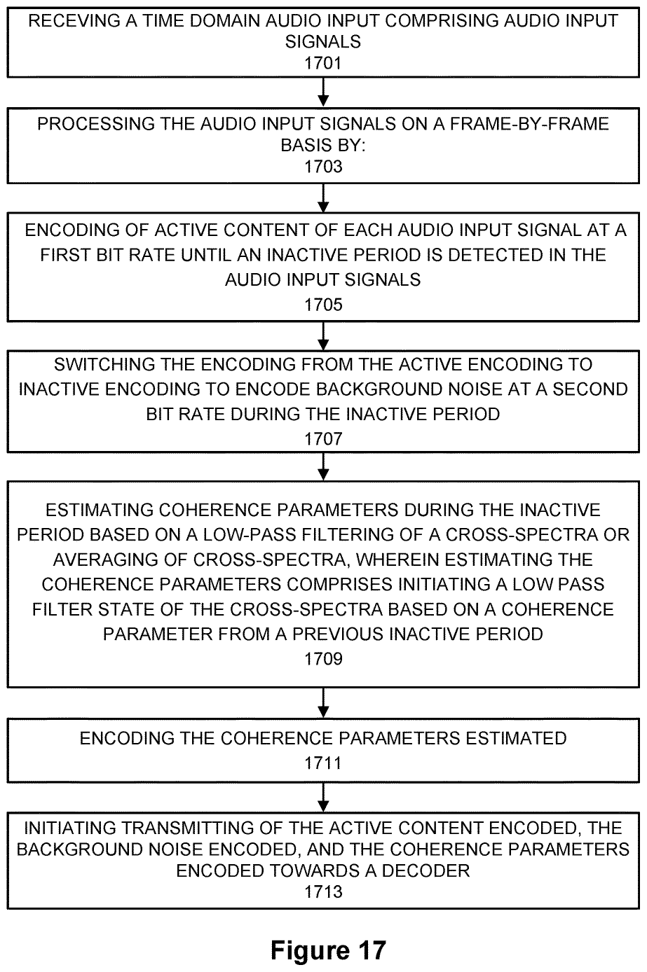

Operations of the encoder 400 (implemented using the structure of the block diagram of FIGS. 4 and 13) will now be discussed with reference to the flow chart of FIG. 17 according to some embodiments of inventive concepts. For example, modules may be stored in memory 1303 of FIG. 13 and these modules may provide instructions so that when the instructions of a module are executed by respective encoder processing circuitry 1301, the encoder 400 performs respective operations of the flow chart.

FIG. 17 illustrates operations an encoder 400 performs in various embodiments. Turning to FIG. 17, in block 1701, the encoder 400 receives a time domain audio input comprising audio input signals. The audio input signals could be speech, music, and combinations thereof.

In block 1703, the encoder 400 processes the audio input signals on a frame-by-frame basis as illustrated in blocks 1705-1711. The encoder 400 can perform the processing in the time domain or in the frequency domain.

In blocks 1705-1711, the encoder 400 encodes each of the audio input signals. Specifically, in block 1705, the encoder 400 encodes active content of each audio input signal at a first bit rate until an inactive period is detected in the audio input signals. A VAD (e.g., VAD 102) or a SAD can be used to detect the inactive period as described above.

In block 1707, the encoder 400 switches the encoding from the active encoding content to inactive encoding to encode background noise at a second bit rate during the pause period. The second bit rate is typically less than the first bit rate as described above.

In block 1709, the encoder 400 estimates coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period.

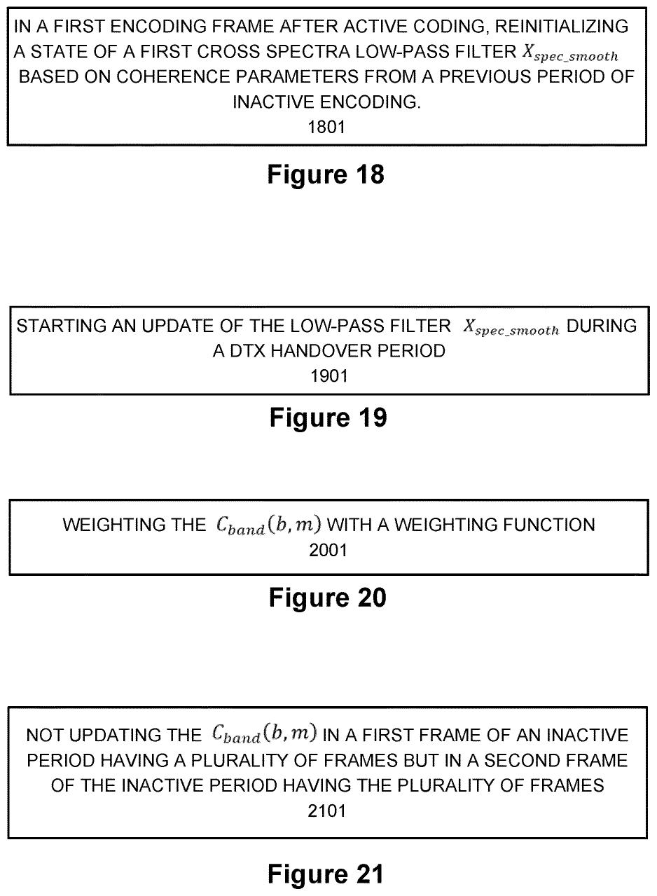

In some embodiments as illustrated in FIG. 18, in estimating the coherence parameters, the encoder 400 in block 1801, in a first encoding frame after active coding, reinitializes a state of a first cross spectra low-pass filter X_{corr_smooth} based on coherence parameters from a previous period of inactive encoding.

In some embodiments, the encoder 400 reinitializes the state of the first cross spectra low-pass filter X_{spec_smooth} based on the last two frames from the previous period of inactive coding.

In other embodiments, the coherence parameters may be various functions of the previous coherence values. For example, encoder 400 may estimate the coherence parameters by picking the second to last one of a previous inactive period, taking an average of the last coherence parameters estimated (and potentially excluding the last one), taking a weighted average of previous coherence values, creating a filtered version of earlier coherence values, e.g. C_{band_filt}(b, m)=(1−γ)·C_{band}_{_{filt}}(b, m−1)+γ·C_{band}(b, m) and use C_{band_filt}(b, m) instead of C_{band}(b, m−2) to reinitialize X_{spec_smooth}, and the like.

In block 1901 of FIG. 19, the encoder 400 starts an update of the second low-pass filter X_{spec_smooth} during a DTX hangover period.

In block 1711, the encoder 400 encodes the coherence parameters estimated.

In block 1713, the encoder 400 initiates transmitting of the active content encoded, the background noise encoded, and the coherence parameters towards a decoder 500.

In some embodiments of processing the audio input signals on a frame-by-frame basis, the encoder 400 processes the audio input signals on a frame-by-frame basis to produce a mono mixdown signal and the encoder 400 encodes the active content of each audio input signal by encoding the active content of the mono mixdown signal.

In yet other embodiments, the encoder 400 processes the audio input signals on a frame-by-frame basis to produce a mono mixdown signal and one or more stereo parameters. In these embodiments, the encoder 400 encodes the active content of the mono mixdown signal and the one or more stereo parameters.

In some embodiments, the encoder 400 determines Xspec smooth in accordance with

$$Xspe {c}_{smooth} [ k , m ] = \sqrt{{C}_{b a n d} ( b , m - 2 ) \cdot \vert {SPD\_L}_{smooth} [ k , m ] {\vert}^{2} \cdot \vert {SPD\_R}_{smooth} [ k , m ] {\vert}^{2} \cdot rand ( k )}$$

$$∀ k ∈ {k}_{b} \qquad b = 0 , 1 , … , {N}_{b a n d} - 1$$

$${SPD\_L}_{smooth} [ k , m ] = ( 1 - α ) \cdot {SPD\_L}_{smooth} [ k , m - 1 ] + α \cdot SPD\_L ( m , k )$$

$${SPD\_R}_{smooth} [ k , m ] = ( 1 - α ) \cdot {SPD\_R}_{smooth} [ k , m - 1 ] + α \cdot SPD\_R ( m , k )$$

$$C ( k , m ) = \frac{{\vert Xspe {c}_{smooth} [ k , m ] \vert}^{2}}{\vert {SPD\_L}_{smooth} [ k , m ] {\vert}^{2} \cdot \vert {SPD\_R}_{smooth} [ k , m ] {\vert}^{2}}$$

$${C}_{b a n d} ( b , m ) = \frac{{\sum }_{k = bandlimit ( b )}^{bandlimit ( b + 1 ) - 1} C ( k , m )}{bandlimits ( b + 1 ) - bandlimits ( b )} b = 0 , 1 , … , {N}_{b a n d} - 1$$

where · indicates multiplication, α is a low pass coefficient, k_{b} is the set of frequency coefficients for band b, bandlimits(b) is a vector containing the limits between the frequency bands, and rand(k) is a complex number with an absolute value=1 and a random phase.

In some other embodiments the encoder 400 determines X_{spec_smooth} in accordance with

$$Xspe {c}_{smooth} [ k , m ] = \sqrt{{C}_{b a n d} ( b , m - 2 ) \cdot \vert {SPD\_L}_{smooth} [ k , m ] {\vert}^{2} \cdot \vert {SPD\_R}_{smooth} [ k , m ] {\vert}^{2}} \frac{Xspe {c}_{smooth} [ k , m ]}{\vert Xspe {c}_{smooth} [ k , m ] \vert}$$

$$∀ k ∈ {k}_{b} \qquad b = 0 , 1 , … , {N}_{b a n d} - 1$$

$${SPD\_L}_{smooth} [ k , m ] = ( 1 - α ) \cdot {SPD\_L}_{smooth} [ k , m - 1 ] + α \cdot SPD\_L ( m , k )$$

$${SPD\_R}_{smooth} [ k , m ] = ( 1 - α ) \cdot {SPD\_R}_{smooth} [ k , m - 1 ] + α \cdot SPD\_R ( m , k )$$

$$C ( k , m ) = \frac{{\vert Xspe {c}_{smooth} [ k , m ] \vert}^{2}}{\vert {SPD\_L}_{smooth} [ k , m ] {\vert}^{2} \cdot \vert {SPD\_R}_{smooth} [ k , m ] {\vert}^{2}}$$

$${C}_{b a n d} ( b , m ) = \frac{{\sum }_{k = bandlimit ( b )}^{bandlimit ( b + 1 ) - 1} C ( k , m )}{bandlimits ( b + 1 ) - bandlimits ( b )} b = 0 , 1 , … , {N}_{b a n d} - 1$$

where · indicates multiplication, α is a low pass coefficient, k_{b} is the set of frequency coefficients for band b, and bandlimits (b) is a vector containing the limits between the frequency bands. As previously described, for clarity, a first Xspecₛₘₒₒₜₕ[k, m] is calculated using Xspecₛₘₒₒₜₕ[k, m]=(1−α)·Xspecₛₘₒₒₜₕ[k, m−1]+α·Xspec(k, m) and the phase of the calculated result is kept by normalizing the calculated result

$$\frac{Xspe {c}_{s m o o t h} [ k , m ]}{\vert Xspe {c}_{s m o o t h} [ k , m ] \vert}$$

and further scaling it by \sqrt{C_{band}(b, m−2)·|SPD_Lₛₘₒₒₜₕ[k, m]|²·|SPD_Rₛₘₒₒₜₕ[k, m]|²}.

In the above ways to determine X_{spec_smooth}, the encoder 400, as illustrated in block 2001 of FIG. 20, weights the C_{band}(b, m) with a weighting function. For example, as described above, the encoder 400 may weight the C_{band}(b, m) with a weighting function in accordance with

$${C}_{b a n d} ( b , m ) = \frac{{\sum }_{k = bandlimit ( b )}^{bandlimit ( b + 1 ) - 1} C ( k , m ) \cdot {\vert LR ( m , k ) \vert}^{2}}{{\sum }_{k = bandlimit ( b )}^{bandlimit ( b + 1 ) - 1} {\vert LR ( m , k ) \vert}^{2}} b = 0 , 1 , … , {N}_{b a n d} - 1$$

where |LR(m, k)|² is a discrete Fourier transform, DFT, energy spectrum for a mono signal being a downmix of the audio input signals.

In some embodiments, the previous inactive period may consist of only one frame. In such instances, the processing of C_{band}(b, m−2) could result in an onset frame being part of the comfort noise, which is not desired. To account for this, the encoder 400, as illustrated in block 2101 of FIG. 21, does not update the C_{band}(b, m−2) in a first frame of an inactive period having a plurality of frames but in a second frame of the inactive period having the plurality of frames.

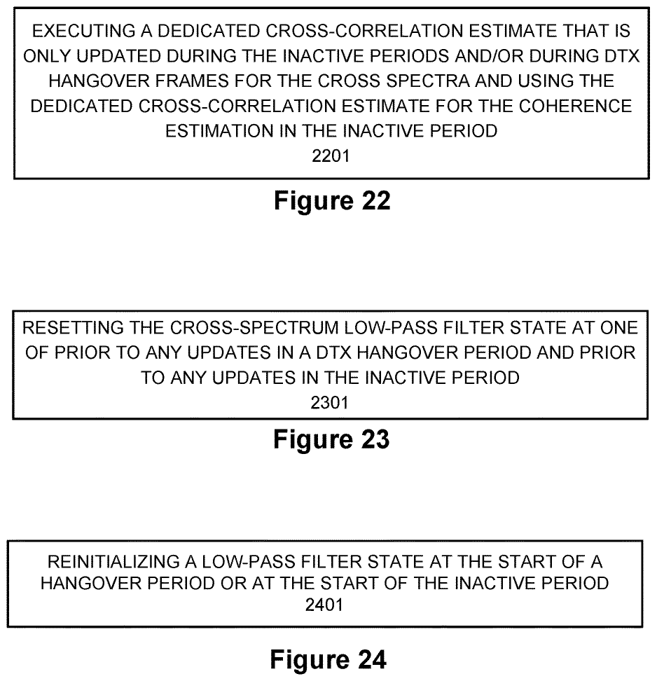

In other embodiments, a dedicated cross-correlation estimate may be used. As illustrated in block 2201 of FIG. 22, the encoder 400 executes a dedicated cross-correlation estimate that is only updated during the pause periods and/or during DTX hangover frames for the cross spectra and using the dedicated cross-correlation estimate for the coherence estimation in the inactive period.

In further embodiments as illustrated in block 2301 of FIG. 23, the encoder 400 speeds up smoothing of cross-spectra by the low-pass filtering by resetting the cross-spectrum low-pass filter state at one of prior to any updates in a DTX hangover period and prior to any updates in the pause period. Additionally, or alternatively, the filter coefficient α can be increased to speed up the impact of new frames being processed.

In yet other embodiments as illustrated in block 2301 of FIG. 23, the encoder 400 speeds up smoothing of cross-spectra by the low-pass filtering by replacing a low-pass filter state at the start of a hangover period or at the start of the inactive period.

In still further embodiments as illustrated in block 2401 of FIG. 24, the encoder 400 reinitializes a low-pass filtering state at the start of a hangover period or at the start of the inactive period.

Although the computing devices described herein (e.g., encoders, decoders, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### Embodiments

Embodiment 1. A method in an encoder (400) to enable generation of comfort noise using an estimated coherence parameter in a network using a discontinuous transmission, DTX, the method comprising:
receiving (1701) a time domain audio input comprising audio input signals;
processing (1703) the audio input signals on a frame-by-frame basis by:
   encoding (1705) active content of each audio input signal at a first bit rate until an inactive period is detected in the audio input signals;
   switching (1707) the encoding from the active encoding content to inactive encoding to encode background noise at a second bit rate during the inactive period;
   estimating (1709) coherence parameters during the inactive period based on a low-pass filtering of cross-spectra or averaging of the cross-spectra, wherein estimating the coherence parameters comprises reinitializing a low pass filter state of the cross-spectra based on a coherence parameter from a previous inactive period;
   encoding (1711) the coherence parameters estimated; and
   initiating transmitting (1713) of the active content encoded, the background noise encoded, and the coherence parameters encoded towards a decoder (500).

Embodiment 2. The method of Embodiment 1, wherein estimating the coherence parameters comprises:
in a first encoding frame after active coding, reinitializing (1801) a state of a first cross spectra low-pass filter X_{spec_smooth} based on coherence parameters from a previous period of inactive encoding.

Embodiment 3. The method of Embodiment 2, wherein reinitializing the state of the first cross spectra low-pass filter X_{spec_smooth} based on coherence parameters from a previous period of inactive encoding comprises reinitializing the state of the first cross spectra low-pass filter X_{spec_smooth} based on a last two frames from the previous period of inactive coding.

Embodiment 4. The method of any of Embodiments 2-3, further comprising:
starting (1901) an update of the low-pass filter X_{spec_smooth} during a DTX hangover period.

Embodiment 5. The method of any of Embodiments 1-4, wherein processing the audio input signals on a frame-by-frame basis comprises processing the audio input signals on a frame-by-frame basis to produce a mono mixdown signal and encoding the active content of each audio input signal comprises encoding the active content of the mono mixdown signal.

Embodiment 6. The method of Embodiment 5, wherein processing the audio input signals on a frame-by-frame basis to produce the mono mixdown signal comprises processing the audio input signals on a frame-by-frame basis to produce the mono mixdown signal and one or more stereo parameters and encoding the active content of the mono mixdown signal comprises encoding the active content of the mono mixdown signal and the one or more stereo parameters.

Embodiment 7. The method of any of Embodiments 2-6, wherein X_{spec_smooth} is determined in accordance with

$$Xspe {c}_{smooth} [ k , m ] = \sqrt{{C}_{b a n d} ( b , m - 2 ) \cdot \vert {SPD\_L}_{smooth} [ m , k ] {\vert}^{2} \cdot \vert {SPD\_R}_{smooth} [ m , k ] {\vert}^{2} \cdot rand ( k )}$$

$$∀ k ∈ {k}_{b} \qquad b = 0 , 1 , … , {N}_{b a n d} - 1$$

$${SPD\_L}_{smooth} [ k , m ] = ( 1 - α ) \cdot {SPD\_L}_{smooth} [ k , m - 1 ] + α \cdot SPD\_L ( k , m )$$

$${SPD\_R}_{smooth} [ k , m ] = ( 1 - α ) \cdot {SPD\_R}_{smooth} [ k , m - 1 ] + α \cdot SPD\_R ( k , m )$$

$$C ( k , m ) = \frac{{\vert Xspe {c}_{smooth} [ k , m ] \vert}^{2}}{\vert {SPD\_L}_{smooth} [ m , k ] {\vert}^{2} \cdot \vert {SPD\_R}_{smooth} [ m , k ] {\vert}^{2}}$$

$${C}_{b a n d} ( b , m ) = \frac{{\sum }_{k = bandlimit ( b )}^{bandlimit ( b + 1 ) - 1} C ( k , m )}{bandlimits ( b + 1 ) - bandlimits ( b )} b = 0 , 1 , … , {N}_{b a n d} - 1$$

where · indicates multiplication, α is a low pass coefficient, k_{b} is the set of frequency coefficients for band b, bandlimits (b) is a vector containing the limits between the frequency bands, and rand(k) is a complex number with an absolute value=1 and a random phase.

Embodiment 8. The method of Embodiment 7, further comprising weighting (2001) the C_{band}(b, m) with a weighting function.

Embodiment 9. The method of Embodiment 8, wherein weighting the C_{band}(b, m) with the weighting function is weighted in accordance with

$${C}_{b a n d} ( b , m ) = \frac{{\sum }_{k = bandlimit ( b )}^{bandlimit ( b + 1 ) - 1} C ( k , m ) \cdot {\vert LR ( m , k ) \vert}^{2}}{{\sum }_{k = bandlimit ( b )}^{bandlimit ( b + 1 ) - 1} {\vert LR ( m , k ) \vert}^{2}} b = 0 , 1 , … , {N}_{b a n d} - 1$$

where |LR(m, k)|² is a discrete Fourier transform, DFT, energy spectrum for a mono signal being a downmix of the audio input signals.

Embodiment 10. The method of any of Embodiments 2-6, wherein X_{spec_smooth} is determined in accordance with

$$Xspe {c}_{smooth} [ k , m ] = \sqrt{{C}_{b a n d} ( b , m - 2 ) \cdot \vert {SPD\_L}_{smooth} [ m , k ] {\vert}^{2} \cdot \vert {SPD\_R}_{smooth} [ m , k ] {\vert}^{2}} \frac{Xspe {c}_{s m o o t h} [ k , m ]}{\vert Xspe {c}_{s m o o t h} [ k , m ] \vert}$$

$$∀ k ∈ {k}_{b} \qquad b = 0 , 1 , … , {N}_{b a n d} - 1$$

$${SPD\_L}_{smooth} [ k , m ] = ( 1 - α ) \cdot {SPD\_L}_{smooth} [ k , m - 1 ] + α \cdot SPD\_L ( k , m )$$

$${SPD\_R}_{smooth} [ k , m ] = ( 1 - α ) \cdot {SPD\_R}_{smooth} [ k , m - 1 ] + α \cdot SPD\_R ( k , m )$$

$$C ( k , m ) = \frac{{\vert Xspe {c}_{smooth} [ k , m ] \vert}^{2}}{\vert {SPD\_L}_{smooth} [ m , k ] {\vert}^{2} \cdot \vert {SPD\_R}_{smooth} [ m , k ] {\vert}^{2}}$$

$${C}_{b a n d} ( b , m ) = \frac{{\sum }_{k = bandlimit ( b )}^{bandlimit ( b + 1 ) - 1} C ( k , m )}{bandlimits ( b + 1 ) - bandlimits ( b )} b = 0 , 1 , … , {N}_{b a n d} - 1$$

where · indicates multiplication, α is a low pass coefficient, k_{b} is the set of frequency coefficients for band b, and bandlimits(b) is a vector containing the limits between the frequency bands.

Embodiment 11. The method of Embodiment 10, further comprising weighting (2001) the C_{band}(b, m) with a weighting function.

Embodiment 12. The method of Embodiment 11, wherein weighting the C_{band}(b, m) with the weighting function is weighed in accordance with

$${C}_{b a n d} ( b , m ) = \frac{{\sum }_{k = bandlimit ( b )}^{bandlimit ( b + 1 ) - 1} C ( k , m ) \cdot {\vert LR ( m , k ) \vert}^{2}}{{\sum }_{k = bandlimit ( b )}^{bandlimit ( b + 1 ) - 1} {\vert LR ( m , k ) \vert}^{2}} b = 0 , 1 , … , {N}_{b a n d} - 1$$

where |LR(m, k)|² is a discrete Fourier transform, DFT, energy spectrum for a mono signal being a downmix of the audio input signals.

Embodiment 13. The method of any of claims 1-12, further comprising:
not updating (2101) the C_{band}(b, m−2) in a first frame of an inactive period having a plurality of frames but in a second frame of the inactive period having the plurality of frames.

Embodiment 14. The method of any of Embodiments 1-12, further comprising:
executing (2201) a dedicated cross-correlation estimate that is only updated during the inactive periods and/or during DTX hangover frames for the cross spectra and using the dedicated cross-correlation estimate for the coherence estimation in the inactive period.

Embodiment 15. The method of any of Embodiments 1-14, further comprising:
resetting (2301) the cross-spectrum low-pass filter state at one of prior to any updates in a DTX hangover period and prior to any updates in the inactive period.

Embodiment 16. The method of any of Embodiments 1-15, further comprising:
reinitializing (2401) a low-pass filter state at the start of a hangover period or at the start of the inactive period.

Embodiment 17. An encoder (400) adapted to enable generation of comfort noise using an estimated coherence parameter in a network using a discontinuous transmission, DTX, the encoder adapted to:
receive (1701) a time domain audio input comprising audio input signals;
process (1703) the audio input signals on a frame-by-frame basis by:
   encode (1705) active content of each audio input signal at a first bit rate until an inactive period is detected in the audio input signals;
   switch (1707) the encoding from the active encoding content to inactive encoding to encode background noise at a second bit rate during the inactive period;
   estimate (1709) coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period;
   encode (1711) the coherence parameters estimated; and
   initiate transmitting (1713) the active content encoded, the background noise encoded, and the coherence parameters encoded towards a decoder (500).

Embodiment 18. The encoder (400) of Embodiment 17, wherein the encoder is further adapted to perform in accordance with any of Embodiments 2-16.

Embodiment 19. An encoder (400) adapted to enable generation of comfort noise using an estimated coherence parameter in a network using a discontinuous transmission, DTX, the encoder comprising:
processing circuitry (1301); and
memory (1303) coupled with the processing circuitry, wherein the memory includes instructions that when executed by the processing circuitry causes the encoder to perform operations comprising:
   receiving (1701) a time domain audio input comprising audio input signals;
   processing (1703) the audio input signals on a frame-by-frame basis by:
      encoding (1705) active content of each audio input signal at a first bit rate until an inactive period is detected in the audio input signals;
      switching (1707) the encoding from the active encoding content to inactive encoding to encode background noise at a second bit rate during the inactive period;
      estimating (1709) coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period;
      encoding (1711) the coherence parameters estimated; and
      initiating (1713) transmitting of the active content encoded, the background noise encoded, and the coherence parameters encoded towards a decoder (500).

Embodiment 20. The encoder (400) of Embodiment 19, wherein the memory includes further instructions that when executed by the processing circuitry causes the encoder to perform any of Embodiments 2-16.

Embodiment 21. A computer program comprising program code to be executed by processing circuitry (1301) of an encoder (400), whereby execution of the program code causes the encoder (400) to perform operations comprising:
receiving (1701) a time domain audio input comprising audio input signals;
processing (1703) the audio input signals on a frame-by-frame basis by:
   encoding (1705) active content of each audio input signal at a first bit rate until an inactive period is detected in the audio input signals;
   switching (1707) the encoding from the active encoding content to inactive encoding to encode background noise at a second bit rate during the inactive period;
   estimating (1709) coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period;
   encoding (1711) the coherence parameters estimated; and
   initiating (1713) transmitting of the active content encoded, the background noise encoded, and the coherence parameters encoded towards a decoder (500).

Embodiment 22. The computer program of Embodiment 21 comprising further program code to be executed by the processing circuitry of the encoder, whereby execution of the program code causes the encoder (400) to perform operations according to any of Embodiments 2-16.

Embodiment 23. A computer program product comprising a non-transitory storage medium including program code to be executed by processing circuitry (1301) of an encoder (400), whereby execution of the program code causes the encoder (400) to perform operations comprising:
receiving (1701) a time domain audio input comprising audio input signals;
processing (1703) the audio input signals on a frame-by-frame basis by:
   encoding (1705) active content of each audio input signal at a first bit rate until an inactive period is detected in the audio input signals;
   switching (1707) the encoding from the active encoding content to inactive encoding to encode background noise at a second bit rate during the inactive period;
   estimating (1709) coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period;
   encoding (1711) the coherence parameters estimated; and
   initiating (1713) transmitting of the active content encoded, the background noise encoded, and the coherence parameters encoded towards a decoder (500).

Embodiment 24. The computer program product of Embodiment 23, wherein the non-transitory storage medium includes further program code to be executed by processing circuitry (1301) of an encoder (400), whereby execution of the further program code causes the encoder (400) to perform operations according to any of Embodiments 2-16.

Embodiment 25. A method implemented by a host (1204) configured to operate in a communication system that further includes an encoder, a decoder, and an audio player, the method comprising:
providing user data for the decoder (500) to decode audio files for the audio player; and
initiating transmissions carrying the audio files to the audio player via a cellular network comprising the encoder (400), wherein the encoder (400) performs the following operations to transmit the user data from the host to the decoder (500):
   receiving (1701) a time domain audio input comprising audio input signals;
   processing (1703) the audio input signals on a frame-by-frame basis by:
      encoding (1705) active content of each audio input signal at a first bit rate until an inactive period is detected in the audio input signals;
      switching (1707) the encoding from the active encoding content to inactive encoding to encode background noise at a second bit rate during the inactive period;
      estimating (1709) coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period;
      encoding (1711) the coherence parameters estimated; and
      initiating (1713) transmitting of the active content encoded, the background noise encoded, and the coherence parameters encoded towards a decoder (500).

Embodiment 26. The method of Embodiment 25 wherein the encoder (400) is further configured to:
perform the method of any of Embodiments 2-16.

Embodiment 27. A host (1204) configured to operate in a communication system to provide an over-the-top, OTT, service, the host comprising:
processing circuitry (1501) configured to provide audio files; and
a network interface (1505) configured to initiate transmissions of the audio files to an encoder (400) in a cellular network for transmission to a decoder (500), the encoder (400) having a network interface (1305) and processing circuitry (1301), the processing circuitry (1301) of the encoder (400) configured to perform the following operations to transmit the audio files from the host to the decoder (500):
   receiving (1701) a time domain audio input comprising audio input signals;
   processing (1703) the audio input signals on a frame-by-frame basis by:
      encoding (1705) active content of each audio input signal at a first bit rate until an inactive period is detected in the audio input signals;
      switching (1707) the encoding from the active encoding content to inactive encoding to encode background noise at a second bit rate during the inactive period;
      estimating (1709) coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period;
      encoding (1711) the coherence parameters estimated; and
      initiating (1713) transmitting of the active content encoded, the background noise encoded, and the coherence parameters encoded towards a decoder (500).

Embodiment 28. The host of Embodiment 27, wherein the processing circuitry of the encoder (400) is further configured to:
perform the method of any of Embodiments 2-16.

References are identified below
U.S. Patent Application Publication No. 20200194013
U.S. Pat. No. 11,417,348
U.S. Pat. No. 11,404,069

1. A method in an encoder to enable generation of comfort noise using an estimated coherence parameter in a network using a discontinuous transmission, DTX, the method comprising:
receiving a time domain audio input comprising audio input signals;
processing the audio input signals on a frame-by-frame basis by:
encoding active content of each audio input signal at a first bit rate until an inactive period is detected in the audio input signals;
switching the encoding from the active encoding content to inactive encoding to encode background noise at a second bit rate during the inactive period;
estimating coherence parameters during the inactive period based on a low-pass filtering of cross-spectra or averaging of the cross-spectra, wherein estimating the coherence parameters comprises reinitializing a low pass filter state of the cross-spectra based on a coherence parameter from a previous inactive period; and
encoding the coherence parameters estimated.

2. The method of claim 1, further comprising:
initiating transmitting of the active content encoded, the background noise encoded, and the coherence parameters encoded towards a decoder.

3. The method of claim 1, wherein estimating the coherence parameters comprises:
in a first encoding frame after active coding, reinitializing a state of a first cross spectra low-pass filter X_{spec_smooth} based on coherence parameters from a previous period of inactive encoding.

4. The method of claim 3, wherein reinitializing the state of the first cross spectra low-pass filter X_{spec_smooth} based on coherence parameters from a previous period of inactive encoding comprises reinitializing the state of the first cross spectra low-pass filter X_{spec_smooth} based on a last two frames from the previous period of inactive coding.

5. The method of claim 3, wherein reinitializing the state of the first cross spectra low-pass filter X_{spec_smooth} based on coherence parameters from a previous period of inactive encoding comprises reinitializing the state of the first cross spectra low-pass filter X_{spec_smooth} based on a second last frame from the previous period of inactive coding.

6. The method of claim 3, further comprising:
starting an update of the low-pass filter X_{spec_smooth} during a DTX hangover period.

7. The method of claim 1, wherein processing the audio input signals on a frame-by-frame basis comprises processing the audio input signals on a frame-by-frame basis to produce a mono mixdown signal and encoding the active content of each audio input signal comprises encoding the active content of the mono mixdown signal.

8. The method of claim 7, wherein processing the audio input signals on a frame-by-frame basis to produce the mono mixdown signal comprises processing the audio input signals on a frame-by-frame basis to produce the mono mixdown signal and one or more stereo parameters and encoding the active content of the mono mixdown signal comprises encoding the active content of the mono mixdown signal and the one or more stereo parameters.

9. The method of claim 3, wherein X_{spec_smooth} is determined in accordance with
$$X s p e {c}_{smooth} [ k , m ] = \sqrt{{C}_{b a n d} ( b , m - 2 ) \cdot \vert {SPD\_L}_{smooth} [ k , m ] {\vert}^{2} \cdot \vert SPD - {R}_{smooth} [ k , m ] {\vert}^{2} \cdot rand ( k )}$$
$$∀ k ∈ {k}_{b} \qquad b = 0 , 1 , … , {N}_{b a n d} - 1$$
$${SPD\_L}_{smooth} [ k , m ] = ( 1 - α ) \cdot {SPD\_L}_{smooth} [ k , m - 1 ] + α \cdot SPD\_L ( k , m )$$
$${SPD\_R}_{smooth} [ k , m ] = ( 1 - α ) \cdot {SPD\_R}_{smooth} [ k , m - 1 ] + α \cdot SPD\_R ( k , m )$$
$$C ( k , m ) = \frac{{\vert Xspe {c}_{smooth} [ k , m ] \vert}^{2}}{\vert {SPD\_L}_{smooth} [ k , m ] {\vert}^{2} \cdot \vert {SPD\_R}_{smooth} [ k , m ] {\vert}^{2}}$$
$${C}_{b a n d} ( b , m ) = \frac{{\sum }_{k = b andlimit ( b )}^{b andlimit ( b + 1 ) - 1} C ( k , m )}{bandlimits ( b + 1 ) - bandlimits ( b )} b = 0 , 1 , … , {N}_{b a n d} - 1$$
where · indicates multiplication, α is a low pass coefficient, k_{b} is the set of frequency coefficients for band b, bandlimits (b) is a vector containing the limits between the frequency bands, and rand(k) is a complex number with an absolute value=1 and a random phase.

10. The method of claim 9, further comprising weighting the C_{band}(b, m) with a weighting function.

11. The method of claim 10, wherein weighting the C_{band}(b, m) with the weighting function is weighted in accordance with
$${C}_{b a n d} ( b , m ) = \frac{{\sum }_{k = bandlimit ( b )}^{bandlimit ( b + 1 ) - 1} C ( k , m ) \cdot {\vert LR ( m , k ) \vert}^{2}}{{\sum }_{k = b andlimit ( b )}^{b andlimit ( b + 1 ) - 1} \vert LR ( m , k ) {\vert}^{2}} b = 0 , 1 , … , {N}_{b a n d} - 1$$
where |LR(m, k)|² is a discrete Fourier transform, DFT, energy spectrum for a mono signal being a downmix of the audio input signals.

12. The method of claim 3, wherein X_{spec_smooth} is determined in accordance with
$$Xspe {c}_{smooth} [ k , m ] = \sqrt{{C}_{b a n d} ( b , m - 2 ) \cdot \vert {SPD\_L}_{smooth} [ k , m ] {\vert}^{2} \cdot \vert SPD - {R}_{smooth} [ k , m ] {\vert}^{2}} \frac{{Xspec}_{smooth} [ k , m ]}{\vert {Xspec}_{smooth} [ k , m ] \vert}$$
$$∀ k ∈ {k}_{b} \qquad b = 0 , 1 , … , {N}_{b a n d} - 1$$
$${SPD\_L}_{smooth} [ k , m ] = ( 1 - α ) \cdot {SPD\_L}_{smooth} [ k , m - 1 ] + α \cdot SPD\_L ( k , m )$$
$${SPD\_R}_{smooth} [ k , m ] = ( 1 - α ) \cdot {SPD\_R}_{smooth} [ k , m - 1 ] + α \cdot SPD\_R ( k , m )$$
$$C ( k , m ) = \frac{{\vert Xspe {c}_{smooth} [ k , m ] \vert}^{2}}{\vert {SPD\_L}_{smooth} [ k , m ] {\vert}^{2} \cdot \vert {SPD\_R}_{smooth} [ k , m ] {\vert}^{2}}$$
$${C}_{b a n d} ( b , m ) = \frac{{\sum }_{k = b andlimit ( b )}^{b andlimit ( b + 1 ) - 1} C ( k , m )}{bandlimits ( b + 1 ) - bandlimits ( b )} b = 0 , 1 , … , {N}_{b a n d} - 1$$
where · indicates multiplication, α is a low pass coefficient, k_{b} is the set of frequency coefficients for band b, and bandlimits (b) is a vector containing the limits between the frequency bands.

13. The method of claim 12, further comprising weighting the C_{band}(b, m) with a weighting function.

14. The method of claim 13, wherein weighting the C_{band}(b, m) with the weighting function is weighed in accordance with
$${C}_{b a n d} ( b , m ) = \frac{{\sum }_{k = bandlimit ( b )}^{bandlimit ( b + 1 ) - 1} C ( k , m ) \cdot {\vert LR ( m , k ) \vert}^{2}}{{\sum }_{k = b andlimit ( b )}^{b andlimit ( b + 1 ) - 1} \vert LR ( m , k ) {\vert}^{2}} b = 0 , 1 , … , {N}_{b a n d} - 1$$
where |LR(m, k)|² is a discrete Fourier transform, DFT, energy spectrum for a mono signal being a downmix of the audio input signals.

15. The method of claim 1, further comprising:
not updating the C_{band}(b, m−2) in a first frame of an inactive period having a plurality of frames but in a second frame of the inactive period having the plurality of frames.

16. The method of claim 1, further comprising:
executing a dedicated cross-correlation estimate that is only updated during the inactive periods and/or during DTX hangover frames for the cross spectra and using the dedicated cross-correlation estimate for the coherence estimation in the inactive period.

17. The method of claim 1, further comprising:
resetting the cross-spectrum low-pass filter state at one of prior to any updates in a DTX hangover period and prior to any updates in the inactive period.

18. The method of claim 1, further comprising:
reinitializing a low-pass filter state at the start of a hangover period or at the start of the inactive period.

19.-20. (canceled)

21. An encoder adapted to enable generation of comfort noise using an estimated coherence parameter in a network using a discontinuous transmission, DTX, the encoder comprising:
processing circuitry; and
memory coupled with the processing circuitry, wherein the memory includes instructions that when executed by the processing circuitry causes the encoder to perform operations comprising:
receive a time domain audio input comprising audio input signals;
process the audio input signals on a frame-by-frame basis by:
encode active content of each audio input signal at a first bit rate until an inactive period is detected in the audio input signals;
switch the encoding from the active encoding content to inactive encoding to encode background noise at a second bit rate during the inactive period;
estimate coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period; and
encode the coherence parameters estimated.

22. The encoder of claim 21, wherein the memory includes further instructions that when executed by the processing circuitry causes the encoder to perform further operations comprising:
initiate transmission of the active content encoded, the background noise encoded, and the coherence parameters encoded towards a decoder.

23.-24. (canceled)

25. A computer program product comprising a non-transitory storage medium including program code to be executed by processing circuitry of an encoder, whereby execution of the program code causes the encoder to perform operations comprising:
receive a time domain audio input comprising audio input signals;
process the audio input signals on a frame-by-frame basis by:
encoding active content of each audio input signal at a first bit rate until an inactive period is detected in the audio input signals;
switch the encoding from the active encoding content to inactive encoding to encode background noise at a second bit rate during the inactive period;
estimate coherence parameters during the inactive period based on a low-pass filtering of cross-spectra or averaging of the cross-spectra, wherein estimating the coherence parameters comprises initiating a low pass filter state of the cross-spectra based on a coherence parameter from a previous inactive period; and
encode the coherence parameters estimated.

26. The computer program product of claim 25, wherein the non-transitory storage medium includes further program code to be executed by processing circuitry of an encoder, whereby execution of the further program code causes the encoder to perform further operations comprising:
initiate transmission of the active content encoded, the background noise encoded, and the coherence parameters encoded towards a decoder.
